(19) United States
(12) Patent Application Publication
(10) Pub. No.: US 2016/0263870 A1
(43) Pub. Date: Sep. 15, 2016

(54) Laminated Patterned Liner

(71) Applicant: Rosario Pepe, Lafayette, NJ (US)

(72) Inventor: Rosario Pepe, Lafayette, NJ (US)

(21) Appl. No.: 14/644,847

(22) Filed: Mar. 11, 2015

(51) Int. Cl. B32B 27/08; B32B 27/30; B32B 3/30

(52) U.S. Cl. CPC B32B 27/08; B32B 3/30; B32B 27/304; B32B 2307/714; B32B 2607/02; B32B 2250/02

(57) ABSTRACT

A laminated liner material can be applied as either a pool liner or a wall covering. The liner comprises a lower substrate layer made of pool-grade or wall-covering-grade PVC, depending on the application. The substrate layer is imprinted with a decorative pattern appropriate to the application. The decorative pattern is “blocked in” and protected from degrading external factors by an upper laminate layer of double polish clear (DPC) PVC.

### FIELD OF INVENTION

The present invention relates to the fields of polyvinyl chloride (PVC) swimming pool liners and wall coverings. More particularly, the present invention relates to PVC pool liners and wall coverings that are imprinted with a decorative pattern.

### BACKGROUND OF THE INVENTION

PVC liners for in-ground swimming pools typically are imprinted with a decorative pattern, which often mimics the appearance of a decorative tile. Since pool liners are heat welded to form seams, however, metallic dyes cannot be used, because they create a barrier to welding. Another limiting factor is the chlorine content of the pool water to which the patterned liner is exposed. Certain dye colors, such as cyan and magenta, are not resistant to chlorine, which attacks and fades them over time.

Similarly, PVC wall coverings are often exposed to sunlight, environmental agents, abrasion and/or actions of young children and pets, tending to cause their decorative patterns to fade, become discolored or marred.

Therefore, it is advantageous to design PVC pool liners and wall coverings in which the imprinted decorative pattern is protected from degradation. This is the principal purpose of the present invention.

### SUMMARY OF THE INVENTION

The present invention is a laminated liner material that can be applied as either a pool liner or a wall covering. The liner comprises a lower substrate layer made of pool-grade or wall-covering-grade PVC, depending on the application. The substrate layer is imprinted with a decorative pattern appropriate to the application. The decorative pattern is “blocked in” and protected from degrading external factors by an upper laminate layer of double polish clear (DPC) PVC. The DPC laminate is formulated either for use in a pool environment or as wall covering, depending on the application.

The DPC laminate layer is fused to the substrate layer in a heated pressure roller lamination system well known in the art. The decorative pattern can be applied as part of the heat lamination, in a one-step process, or the substrate can first be imprinted and then laminated, in a two-step process. Optionally, the laminate layer can be embossed with a texture, such as one that simulates a gunite pool wall.

The DPC laminate allows the substrate's decorative pattern to be clearly visible and unobscured, while simultaneously protecting the pattern and blocking degrading external factors, such as pool water chlorine. Moreover, the laminate can be abraded or discolored without affecting the underlying substrate pattern. In the wall covering application, accidental staining or markings by children can readily be washed off the DPC laminate so that the substrate's decorative pattern remains unmarred.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a schematic rendering of one embodiment of the laminated patterned liner of the present invention.

### DETAILED DESCRIPTION OF THE PREFERRED EMBODIMENT

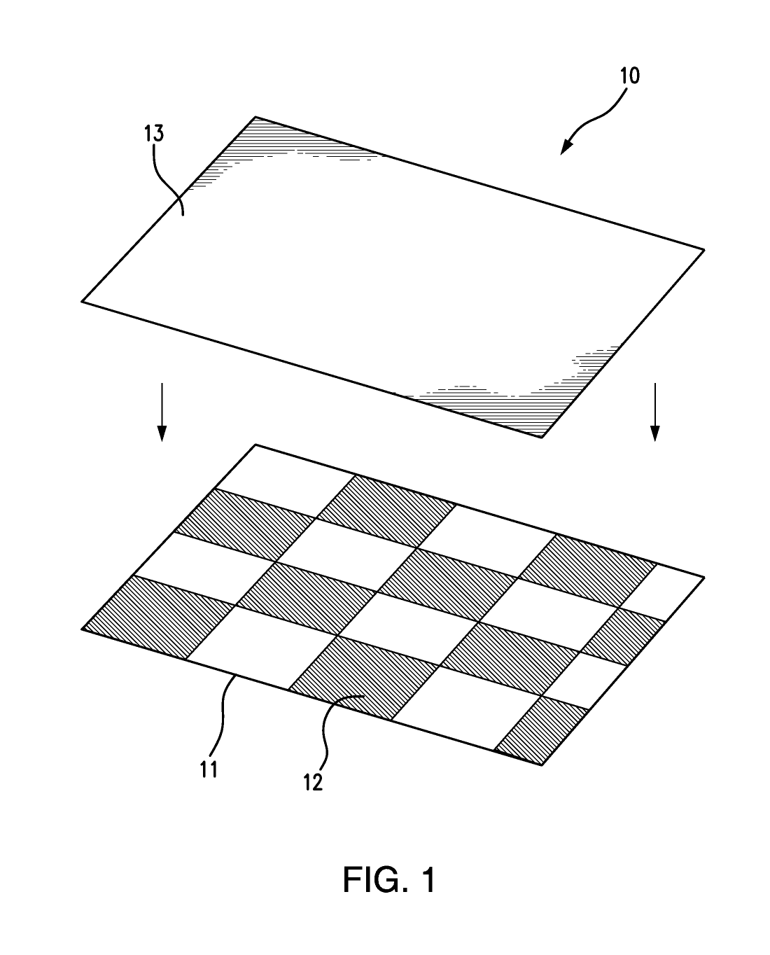

Referring to FIG. 1, one embodiment of the present invention 10 comprises a lower PVC substrate layer 11, imprinted with a decorative pattern 12, to which an upper DPC laminate layer 13 is fused, so as to produce a laminated patterned liner 10. The lamination process is accomplished by running the two layers through heated rollers (approximately 220°-250° F.), with sufficient dwell time for the two layers to become fused together.

The decorative pattern 12 can be applied to the substrate layer either during the lamination process (one-step), or it can be applied prior to lamination (two-step).

For pool liner applications, the substrate PVC is standard pool liner material and the DPC laminate layer also meets pool specifications for resistance to cracking under low temperature conditions. For wall covering applications, a lighter grade of substrate PVC can be used, as well as a thinner laminate layer.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

1. A laminated patterned liner, comprising:
a lower substrate layer consisting of a sheet of pool-grade or wall-covering grade polyvinyl chloride imprinted with a decorative pattern;
an upper laminate layer consisting of a conforming sheet of double polish clear polyvinyl chloride; and
wherein the upper laminate layer is bonded under heat and pressure to the lower substrate layer, so that the upper laminate layer fuses with the lower substrate layer, and such that the decorative pattern of the lower substrate layer remains unobscured, and such that the upper laminate layer covers and protects the decorative pattern.

2. The laminated patterned liner of claim 1, wherein the lower substrate layer and the upper laminate layer are both adapted for use as components of a swimming pool liner.

3. The laminated patterned liner of claim 1, wherein the lower substrate layer and the upper laminate layer are both adapted for use as components of a wall covering.
